(19) United States
(12) Patent Application Publication
(10) Pub. No.: US 2020/0378009 A1
(43) Pub. Date: Dec. 3, 2020

(54) METHOD FOR THE SURFACE MODIFICATION OF AT LEAST ONE COMPONENT AND REACTOR DEVICE FOR CARRYING OUT THE METHOD

(71) Applicant: Schaeffler Technologies AG & Co. KG, Herzogenaurach (DE)

(72) Inventors: Bernd Welzer, Falkensee (DE); Bertram Haag, Uehlfeld (DE); Nikolay Podgaynyy, Adelsdorf (DE); Christian Jakob, Wasserlosen (DE)

(73) Assignee: Schaeffler Technologies AG & Co. KG, Herzogenaurach (DE)

(21) Appl. No.: 16/607,210

(22) PCT Filed: May 9, 2018
(86) PCT No.: PCT/DE2018/100446

§ 371 Date: Oct. 22, 2019

(30) Foreign Application Priority Data
May 17, 2017 (DE) 10 2017 110 680.4
Jun. 9, 2017 (DE) 10 2017 112 736.4

(51) Int. Cl. C23C 22/62; C23C 22/82; C23C 22/73; C23G 1/08; F16C 33/64

(52) U.S. Cl. CPC C23C 22/62; C23C 22/82; F16C 33/64; C23G 1/08; C23C 22/73

(57) ABSTRACT

A process for surface modification of a component includes providing a first reactor for a main procedure and a second reactor for an ancillary procedure. The first reactor is charged with a main medium, a component is provided to the first reactor, and the main procedure is performed by bathing the component in the main medium to bring about a chemical change onto a surface of the component. The second reactor is charged with an ancillary medium, the component is provided to the second reactor, and the ancillary procedure is performed by bathing the component in the ancillary medium to treat the surface of the component. The chemical change is a surface modification that takes the form of bluing or phosphatizing, the surface modification forms a conversion coating, and the component has a diameter or dimensions in the range from 0.5 m to 12 m.

### CROSS-REFERENCE TO RELATED APPLICATIONS

This application is the United States National Phase of PCT Appln. No. PCT/DE2018/100446 filed May 9, 2018, which claims priority to German Application Nos. DE102017110680.4 filed May 17, 2017 and DE102017112736.4 filed Jun. 9, 2017, the entire disclosures of which are incorporated by reference herein.

### TECHNICAL FIELD

The disclosure relates to a process for the surface modification of at least one component, where the surface modification takes the form of bluing or of phosphatizing, where a conversion coating is formed.

### BACKGROUND

Surface treatment processes are frequently provided during the production of components. Surface treatments serve inter alia to provide protection from corrosion and in particular increase the lifetime of the components. Various surface treatments are applied here as required by the material used, examples being coatings applied by electroplating, by solution-chemistry methods, or by vapor deposition methods. The chemicals used are often hazardous to the environment, and for this reason various processes have been developed and carried out for surface treatment in reactors.

DE 10 2007 061 193 A1 discloses a process of this type which takes the form of bluing for the surface treatment of a component subject to stress deriving from rolling motion.

The document DE 10 2006 034 382 A1 discloses an apparatus for the electrochemical coating of workpieces, comprising a coating reactor to which an electrolyte is introduced and which comprises a coating receptacle that holds the workpiece to be coated.

The patent application DE 10 2015 222 902 of the applicant, discloses a process for the surface treatment of a component, using an apparatus comprising a reactor to which the component is charged. During the surface treatment of the component, various media are charged in succession to the reactor. Phenomena observed during said process are contamination of the individual media used and entrainment of residues of one medium into other media which are introduced into, and in turn discharged from, the reactor. This necessitates early replacement of the treatment media.

### SUMMARY

The disclosure is directed to a process for the surface modification of at least one component with a diameter or dimensions in the range from 0.5 m to 12 m, in that in at least one first reactor at least one main procedure is carried out and in at least one second reactor at least one ancillary procedure is carried out. The at least one component is introduced into the at least one first reactor into which at least one main medium has been charged, and thus the at least one component has been provided to the at least one first reactor. During the at least one main procedure, the at least one component is bathed in the at least one main medium, and the at least one main medium brings about a chemical change onto the surface of the at least one component. The at least one component is introduced into the at least one second reactor into which at least one ancillary medium has been charged, and thus the at least one component has been provided to the at least one second reactor. During the at least one ancillary procedure, the at least one component is bathed in the ancillary medium, the ancillary medium treats the surface of the at least one component, and the surface modification takes the form of bluing or of phosphatizing, forming a conversion coating.

Particular preference is given to treatment of components with a diameter or dimensions in the range from 1.2 m to 4 m. In the case of round components here, a minimal diameter of 0.5 m and a maximal diameter of 12 m, e.g., 4 m, is provided. In the case of non-round parts, at least one dimension, i.e. a length dimension and/or a width dimension and/or a depth dimension, is at least 0.5 m and at most 12 m, e.g., at most 4 m.

It is possible either to treat only one component in a reactor or to treat a plurality of components simultaneously. For example, at least two, e.g., at least three, components are introduced simultaneously into a reactor and treated therein. For example, three to ten components may be treated simultaneously in a reactor.

The disclosure is also directed to a reactor apparatus for the conduct of the disclosed process, with at least one heated first reactor, at least one second reactor, and at least one transport device. The at least one first reactor has at least one holder device for holding the at least one component, and the at least one second reactor has at least one further holder device for holding the at least one component. The at least one transport device is for introducing the at least one component into a first reactor or a second reactor and/or for removing the at least one component from a first reactor or a second reactor.

The disclosed process and the disclosed reactor apparatus permit effective separation of main media and ancillary media via use of separate reactors, thus permitting reliable avoidance of contamination of a main medium by an ancillary medium or vice versa. It is thus possible to achieve a long usage time of the individual media in the process, and economies in use of said media. The term “medium” used here and hereinafter means a main medium and/or an ancillary medium.

The term “holder device” here means any of the devices that are suitable for providing availability of the at least one component in a medium over the intended treatment period: the holder device can be a shelf that is fixedly installed on the respective reactor or that is merely temporarily introduced into, or attached on, the reactor, an example being a separate pedestal-shelf or the like. Such shelves or pedestal-shelves can moreover simultaneously hold a plurality of components, and therefore simultaneous treatment of a plurality of components can also take place in a single reactor. A holder device can moreover be provided via a crane which transfers the at least one component, optionally inclusive of a pedestal-shelf, into the respective reactor for the treatment, and which holds same in the respective reactor during the intended treatment period.

In comparison with a process using a reactor apparatus which comprises only one reactor to which the various ancillary and main media required are charged in succession, the disclosed reactor apparatus has the advantage that process times can be reduced and heat losses at the reactors can be minimized. The walls of a reactor generally undergo significant cooling during the pumped discharge of a medium and have to be brought back to operating temperature by the newly charged medium. This costs time and energy which can be saved by using a plurality of reactors arranged in series alongside one another.

The at least one ancillary procedure is by way of example cleaning of the surface of the component by rinsing. In particular, the at least one ancillary procedure is an etching procedure, an activation procedure or a surface-sealing procedure. The surface-sealing procedure can specifically be a surface-adsorption procedure. The at least one ancillary procedure can take place before and/or after the at least one main procedure.

In an example embodiment, after introduction of the at least one component, the at least one first reactor and/or the at least one second reactor are closed until the end of a treatment period in the respective reactor. To this end, for example, at least one covering element, e.g., one cover, is provided for the respective reactor. The covering element permits rapid temperature equalization between the medium in the reactor and the at least one component, and also, where appropriate, a separate pedestal-shelf and the like. Evaporative loss of the medium from the respective reactor is moreover prevented, and heat loss is minimized, and it is therefore possible to minimize any heating of the reactor. In an alternative to closure of the respective reactor it is also possible merely to provide a hood or the like, where these elements reduce heat losses and evaporative losses.

The manner in which the process treats the at least one component can be as follows:

The at least one component is first introduced into a second ancillary reactor in the form of a degreasing reactor and degreased by means of a first ancillary agent.

The at least one degreased component is then introduced into a further second ancillary reactor in the form of a rinsing or nucleation reactor and treated by means of at least one further ancillary agent, e.g., rinsed or nucleated.

The at least one treated component is then introduced into a first reactor in the form of a first bluing or phosphatizing reactor. In a first step in that reactor, the at least one component is blued or phosphatized.

The at least one component is then optionally introduced into a further first reactor in the form of a second bluing or phosphatizing reactor. In a second step in that reactor, the bluing or phosphatizing of the component is continued and finally concluded.

There can be associated further process steps here in further ancillary reactors for the posttreatment of the blued or phosphatized component, for example for the rinsing of the component and optionally also for intermediate rinsing between two main procedures.

The at least one further ancillary medium may be charged from an external container to the at least one second reactor and returned to the external container after the treatment of the component. It is thus possible to charge, to the at least one second reactor, various ancillary media required during the the process. It is therefore possible that, during the process, the at least one component is introduced repeatedly into a second reactor to which various ancillary media are charged in succession. After the treatment of the surface of the at least one component by the ancillary medium, the ancillary medium can accordingly optionally be discharged from the second reactor. The discharge of the ancillary medium can optionally be additionally assisted by pressure resulting from introduction of compressed air.

At least one main medium may be heated during the at least one main procedure. Introduction of a component preheated to bath temperature results in no, or at least slight, reduction of the temperature of the main medium, with the result that it is merely necessary to maintain the temperature of the main medium during the treatment time. In contrast, introduction of at least one component that has not been preheated reduces the temperature of the main medium, with resultant requirement for heating to reinstate the required temperature of the main medium and for subsequent maintenance of the temperature of the main medium during the treatment time.

If the at least one component is blued, a first main medium used in the first bluing reactor may be an aqueous solution having a nitrite concentration of at least 80 g/l. In an example embodiment, the component remains for at most five minutes immersed into the first main medium, the temperature of which is in the range from 132 to 137° C. The nitrite in the first main medium may take the form of sodium nitrite. Nitrate concentration in the first main medium here is at most one fourth of the nitrite concentration.

In the second bluing reactor, a second main medium may be a further aqueous solution which has a higher nitrite concentration than the first main medium. The nitrite concentration in the second main medium here is preferably in the range from 140 to 170 g/l. In an example embodiment, the at least one component remains for at least 12 minutes immersed into the second main medium, the temperature of which is higher by from 3 to 5 Kelvin than that of the first ancillary medium. The nitrite in the second main medium may also take the form of sodium nitrite.

In the phosphatizing procedure, chemical reactions of the metallic surface of the respective component with aqueous phosphate solutions form a conversion layer made of fixedly adhering metal phosphate compounds which improve the overall frictional and wear properties of the component.

The layer formed by the phosphatizing procedure is by way of example a manganese phosphate layer, a zinc phosphate layer, a zinc calcium phosphate layer or an iron phosphate layer.

In this connection, it is known to the person skilled in the art that pretreatments or mechanical influences can have various effects on the formation of the phosphate layer: by way of example, it is known that grinding or bombardment with sand grains or steel shot create ideal conditions for the development of the layer. The surface is thus covered with a large number of active centers, resulting in great uniformity of “pickling” action leading to layer formation, and of development of the coating. The use of acids such as hydrochloric acid, sulfuric acid or phosphoric acid reduces the number of crystallization nuclei present for formation of the layer of the metal surface, and coatings produced after said treatments are therefore thick and coarsely crystalline. On a metal surface with many nuclei, crystallization generally begins simultaneously at many sites, and after a short time phosphate crystals on the surface therefore combine with one another. Values for layer thickness, layer roughness and time required to complete layer development remain low. Metal surfaces with few crystallization nuclei give a thick, coarsely crystalline layer, where the time required to complete development is substantially longer.

It is also known to the person skilled in the art that a specific prerinsing procedure can influence the nature of a phosphate layer. Brief contact of metal surfaces with prerinsing solutions eliminates the layer-enlarging and layer-thickening effects of pickling in acids. Thin, finely crystalline layers are produced, while at the same time at least the phosphatizing time decreases. Brushing or abrasion of the metal surface before phosphatizing has an effect similar to that of these activating prerinsing procedures. Particularly thin, finely crystalline layers are thus again produced. Another known mechanical means of influencing development of the layer is the manner in which the metal surface is brought into contact with the phosphatizing solution. The thickness of the coating formed generally decreases with increasing relative velocity between metal surface and phosphatizing solution.

Phosphatizing can by way of example take place in a zinc phosphatizing bath as main medium with the conventional contents of phosphoric acid, zinc oxide, sodium nitrate, iron, nickel, oxalates and organic accelerator based on nitrobenzenesulfonic acid.

Accordingly, in the bluing or phosphatizing procedure, the at least one component is bathed in the at least one main medium. Contact of the surface of the at least one component with the respective main medium leads to a chemical reaction with the upper layers of the component. It is preferable that the layer thickness of the upper layers is up to about 2 μm.

The disclosure proposes a process for the surface modification of at least one component, in particular at least one component made of iron or of a steel, in particular of non-stainless steel.

In an example embodiment, the component that is treated is a constituent of an antifriction bearing, in the form of a bearing ring, for example. This can be an external ring or an internal ring. However, cages or rolling elements can also be subjected to surface modification. It is moreover also possible to treat other large parts, for example bodywork components, transmission parts, axles, gearwheels, panels and the like.

The at least one component may be configured as a constituent of a large antifriction bearing. The constituent of the antifriction bearing can be manufactured from iron-containing, non-stainless materials, provided with corrosion-protection through surface modification in the form of bluing or phosphatizing.

The at least one component, e.g., the constituent of the large antifriction bearing, may be a precision component. A bluing procedure especially causes only negligible change of the dimensions of the precision component. Alternatively, the component is configured as any desired precision component having large dimensions.

For the surface modification procedure, the at least one component is introduced into one of the reactors. For example, the component here is secured in the reactor and/or laid or retained in the reactor. Annular components may be introduced horizontally into the reactor, at least one such component such as a bearing ring being arranged horizontally in at least one, e.g., in each, of the reactors present.

As already stated above, each reactor has a holder device for the component. The holder device can by way of example be configured as a shelf for the component, onto which the component is placed. Alternatively, the holder device can be configured as a clamp, where the clamp secures, or grips, the component. The arrangement in the reactor here may be achieved by means of a holder device which is arranged immovably in the reactor or which is configured movably. A movable holder device thus serves to hold the at least one component and moreover serves to move the at least one component in the respective medium during the treatment period, for example.

The ancillary medium may be configured as a cleaning agent for the degreasing and/or the cleaning of the surface of the component, for example. Specifically, the ancillary medium may be configured as a cleaning agent with etching effect. The ancillary medium can moreover be configured as an activating agent. The activating agent can activate the surface of the respective component, where the activation prepares the surface for the chemical reaction in the at least one main procedure. Specifically, the activation of the surface leads to acceleration of the reaction carried out in the at least one main procedure, for example via catalytic effect, via a surface structure enlarged by means of roughening, for example. Alternatively, the ancillary medium can be configured as a conditioning agent. The ancillary medium can also be used for the nucleation of the surface of the at least one component. For example, the conditioning agent conditions the surface of the at least one component, where the conditioning may suppress competing reactions, specifically undesired side reactions and/or alternative reactions.

The ancillary medium can moreover be configured as an oil. In particular, the oil seals the upper layers of the at least one component which are modified in the at least one main procedure. Alternatively, and/or additionally, the oil is configured as dewatering oil, where the dewatering oil removes, from the surface of the at least one component, water residues resulting from aqueous main media and/or auxiliary media previously used.

A phosphatizing procedure here begins with degreasing of the at least one component followed by nucleation of the degreased surface of the at least one component with crystallization nuclei, for example with nickel crystallization nuclei, where a nickel salt solution is used as ancillary medium. This is followed by the phosphatizing procedure, for example a manganese phosphatizing procedure or zinc phosphatizing procedure. Finally, the at least one phosphatized component is rinsed.

For the purposes of the disclosure, the surface modification is configured as conversion coating, namely as bluing or as phosphatizing. The main medium is moreover configured as a bluing agent or as a phosphatizing agent. The reaction is, for example, a redox reaction, and specifically the surface of the at least one component is oxidized.

The iron in the material of the at least one component may be oxidized at the surface of the component. For example, during the bluing procedure, the iron forms mixed oxide layers known as noble rust, made of divalent and trivalent iron, where the noble rust protects the layers situated thereunder from corrosion.

In a further development of the disclosure, the main medium can be configured as an acid or as an aqueous alkali. In particular, the main medium may be configured as an acidic or alkaline solution. The main medium may optionally be a molten salt, e.g., a molten low-melting-point salt or salt mixture.

The bluing procedure or phosphatizing procedure is achieved in the reactor apparatus of the invention with the aid of a plurality of reactors, where the at least one component is introduced by means of at least one transport device, for example by way of a crane, into a main medium and/or an ancillary medium and is in turn lifted out of same after the treatment. The crane can also retain the at least one component in the reactor during the treatment period.

The main medium in the heated first reactor is heated during the at least one main procedure. For example, after the main medium has been charged to the first reactor, and/or during the at least one main procedure, said medium is heated to, and maintained at, boiling point.

A second reactor to which ancillary medium has been charged can likewise be configured as heatable, so that an ancillary medium can be heated therein. Before charging to a second reactor, the ancillary medium can be preheated, e.g., heated to its boiling point, in order to ensure that, after charging to the second reactor, the time required for said reactor to reach its operating temperature is minimized.

A reactor may be configured as a container that, when viewed from above, is rectangular or cylindrical. In the case of an annular component, an example embodiment can use a reactor shape which, when viewed from above, has an annular cross section. It is thus possible to achieve a quantitative saving in media required to treat the annular component.

The reactor apparatus may include a plurality of first reactors and a plurality of second reactors. For example, the reactor apparatus may have two first reactors and two second reactors. At least one of the second reactors may be heated.

In an example embodiment, the reactor apparatus comprises a number n of external containers to provide availability of the at least one main medium and of the at least one ancillary medium, where at least a number m of reactors is present, where n≥m.

In an example embodiment, an ancillary medium is charged, e.g., pumped, from such an external container into one of the reactors. Once treatment has ended, the ancillary medium is discharged from the reactor and returned to, and/or pumped into, the external container. This is achieved by way of example by way of piping or hoses.

A heatable configuration of such an external container has accordingly moreover proven to be successful.

It is therefore possible by way of example to introduce different main media in succession into a first reactor and/or to introduce different auxiliary media in succession into a second reactor, while the at least one component to be treated therewith remains in the reactor, for example.

The reactor apparatus may comprise at least one conveying device for the transfer of at least one ancillary medium from one of the external containers into a second reactor. To this end, the conveying device comprises coupling elements, e.g., piping or hoses, where the medium flows through the coupling elements from the external container to the reactor and vice versa. In an example embodiment, the conveying device comprises at least one pump, where the at least one pump pumps the medium. The conveying device optionally comprises a piping system with a manifold, where the manifold transfers the required medium.

The arrangement can have the external containers in a position above the reactors, so that transfer of a medium in the direction of a reactor is brought about solely by gravity. Insofar as the arrangement has a reactor on a lifting platform which can lift the reactor into a position above the at least two external containers, it is also possible to achieve return flow of the medium into the external container by means of gravity. It is therefore also possible, in the absence of a pump, to transfer the medium from one of the external containers to a reactor, and in particular from a reactor to an external container.

On discharge from a reactor and/or during return to an external container, the medium can be filtered. A filter is used here in order to prevent contamination of the medium remaining in the external container, for example. It is thus possible to reuse the medium for a plurality of surface modification procedures, thus reducing consumption of the medium and therefore reducing process costs.

It is moreover possible to achieve cleaning of the respective medium in the region of an external container by connecting a cleaning circuit to the external container. This type of cleaning procedure can be applied to media used for rinsing, for example water.

The reactor apparatus may include at least two external containers, where the at least two external containers hold at least one main medium and one ancillary medium.

An external container can have preheating elements for the preheating of the medium stored therein. For example, the external container here is configured with thermal insulation and with possibility for closure, in order to accelerate the heating of the medium and to minimize loss of heat to the environment.

The pressure in a reactor is kept constant at least during the at least one main procedure and/or the at least one ancillary procedure. To this end, the reactor may have a pressure-relief valve, where the pressure-relief valve provides equalization of the increasing pressure in the covered reactor during the heating of the main medium and/or of the ancillary medium, for example. The pressure-relief valve can moreover be utilized to assist discharge of medium from a reactor.

The pressure-relief valve may be coupled to an air scrubber, where the air scrubber cleans the vapor discharged from a reactor. The medium separated therefrom can be returned to an external container by way of piping or hose lines. This reduces loss of the medium and discharge into the surrounding area, thus protecting health and conserving the environment.

In a further development of the disclosure, the medium in the reactor may be kept in motion by at least one stirrer apparatus. Directional flow may be generated in the medium, for example. This results in uniform mixing throughout the medium and uniform flow onto the at least one component. In an example embodiment, the movement of the medium moreover achieves uniform heating of the medium. Specifically, the movement prevents formation of phases, for example as a result of alteration of the main medium in the vicinity of the surface of the at least one component by the redox reaction at the surface of the component. Stirrer apparatuses used can be mechanical stirrers and/or nozzle arrangements, where the respective medium can flow by way of the nozzle arrangements into the reactor into which medium has already been charged. Alternatively, it is however also possible to introduce gases through nozzles, e.g., inert gas.

### BRIEF DESCRIPTION OF THE DRAWINGS

Other features, advantages and effects of the disclosed process and of the disclosed reactor apparatus are apparent from the description below of exemplary embodiments, and also from the attached figures, where:

FIG. 1 is a diagrammatic sectional side view of a first reactor apparatus,

FIG. 2 is a second diagrammatic sectional side view of the first reactor apparatus,

FIG. 3 is a third diagrammatic sectional side view of the first reactor apparatus,

FIG. 4 is a fourth diagrammatic sectional side view of the first reactor apparatus,

FIG. 5 is a diagrammatic sectional side view of a second reactor apparatus, and

FIG. 6 is a possible process sequence.

### DETAILED DESCRIPTION

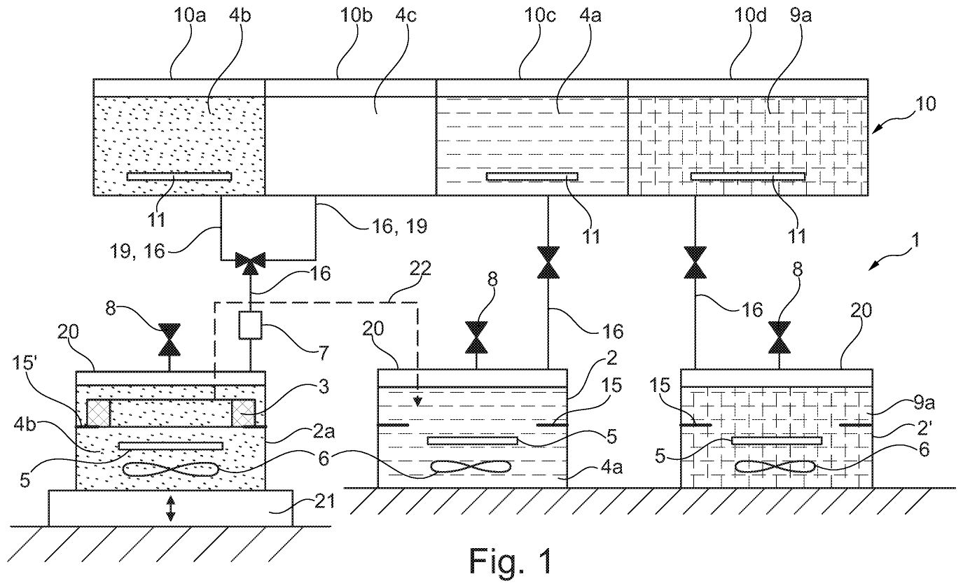

FIG. 1 is a diagrammatic sectional side view of a first reactor apparatus 1. The first reactor apparatus 1 comprises a first reactor 2 and a further first reactor 2′, where in each of the first reactors 2, 2′ a main procedure is carried out. A first main medium 4a has been charged to the first reactor 2 and said reactor is heated by means of a heating element 5. A second main medium 9a has been charged to the further first reactor 2′ and said reactor is likewise heated by a heating element 5.

The first reactor apparatus 1 moreover comprises a second reactor 2a in which ancillary procedures are carried out. The second reactor 2a is arranged on a lifting platform 21 which is configured to lift and lower the reactor 2a. A first ancillary medium 4b has been charged to the second reactor 2a and said reactor is heated by means of a heating element 5.

In a position above the reactors 2, 2′, 2a there is a container arrangement 10 provided which comprises four external containers 10a, 10b, 10c, 10d. The external container 10a has a preheating element 11 and contains the first ancillary medium 4b. The external container 10b has no preheating element and contains the second ancillary medium 4c. The external container 10c has a preheating element 11 and contains the first main medium 4a. The external container 10d likewise has a preheating element 11 and contains the second main medium 9a.

The upper side of each reactor is closed by means of a cover 20, each cover 20 having a pressure-relief valve 8. Each reactor moreover has a stirrer apparatus 6, in order to circulate the medium present therein.

By way of a supply line 16 and, respectively, a discharge line 19, the second reactor 2a has connection not only to the first external container 10a for the supply and discharge of first ancillary medium 4b but also to the second external container 10b for the supply and discharge of second ancillary medium 4c. There is moreover a filter 7 present, which filters contaminants from the ancillary media 4b, 4c. FIG. 1 shows that the first ancillary medium 4b has been charged to the second reactor 2a; once the valve provided has been opened, gravity causes said medium to flow into the second reactor 2a.

By way of a further supply line 16, the first reactor 2 has connection to the external container 10c. Once the valve provided has been opened, the first main medium 4a can then be passed into the first reactor 2.

By way of a further supply line 16, the further first reactor 2′ has connection to the external container 10d. Once the valve provided has been opened, the second main medium 9a can then be passed into the further first reactor 2′.

The basic shape of each reactor 2, 2′, 2a here is cylindrical.

In an embodiment not depicted, however, it is also possible that a reactor 2, 2′, 2a has a cylindrical section and a conical section, where the lower side of the cylindrical section is open and the conical section begins here. The narrowest part of the conical section here is oriented downward and has properties of a funnel. In particular here, the radius of the cylindrical section is greater than the height of the cylindrical section. The radius of the conical section is the same as that of the cylindrical section. The height of the conical section is less than the height of the cylindrical section. In particular, the height of the conical section is more than half of the height of the cylindrical section.

Each reactor 2, 2′, 2a has a holder device 15, 15′ for a component 3. The holder devices 15, 15′ for the component 3 are, however, merely depicted diagrammatically and can also be realized in another manner.

In all of the figures, the arrangement of a heating element 5 or of a preheating element 11 is merely depicted diagrammatically: there can be a plurality of heating elements 5 or preheating elements 11 provided per reactor and, respectively, external container 10a-10d. By way of example there can be two annular heating elements provided per reactor, and the arrangement here can have one element inside of, and one element outside of, the annular component 3 arranged horizontally in the reactor.

In FIG. 1, the component 3—depicted in sectional view—is arranged within the first ancillary medium 4b in the second reactor 2a. The first ancillary medium 4b here serves for degreasing of the component 3. The component 3 is configured here as an annular workpiece, in particular as a constituent of an antifriction bearing, for example a bearing ring.

The first ancillary medium 4b has been charged to the second reactor 2a in a manner such that the first ancillary medium 4b completely covers the component 3. After degreasing of the component 3 in the second reactor 2a, the degreased component 3 is transported by means of a transport device 22, merely indicated diagrammatically, out of the second reactor 2a and into the heated first reactor 2. Before the degreased component 3 is introduced into the first reactor 2, said component may be heated approximately to the temperature of the first main medium 4a.

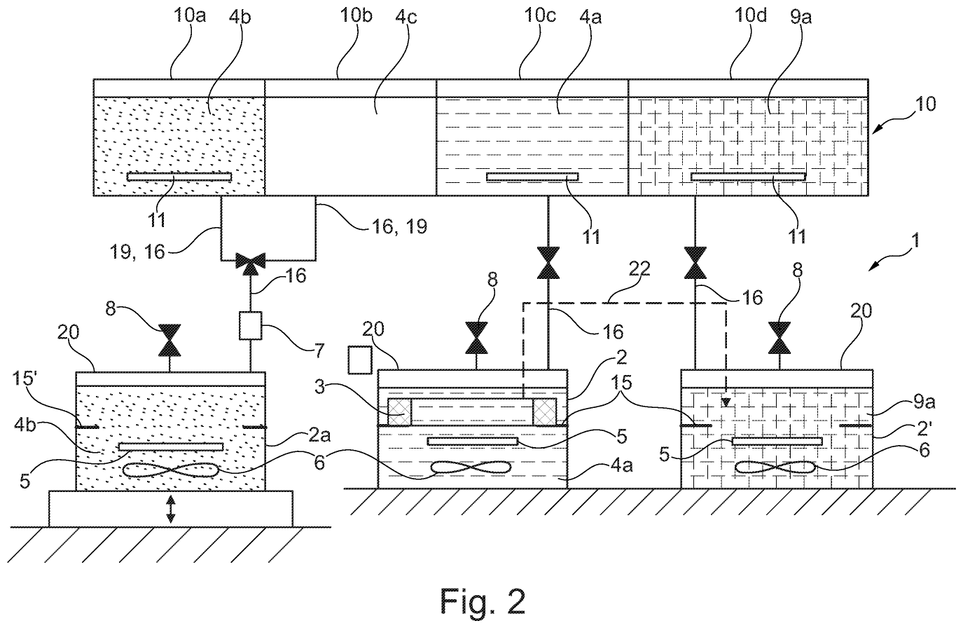

In FIG. 2, bluing of the degreased, preheated component 3 then takes place in the first reactor 2, which corresponds here to a first bluing reactor. The first bluing reactor uses, as a first main medium 4a, an aqueous solution having a nitrite concentration of at least 80 g/l. In an example embodiment, the component 3 remains for at most five minutes immersed into the first main medium 4a, the temperature of which is in the range from 132° C. to 137° C. The nitrite in the first main medium 4a may take the form of sodium nitrite. Nitrate concentration in the first main medium 4a here is at most one quarter of the nitrite concentration.

The first main medium 4a has been charged to the first reactor 2 in a manner such that the first main medium 4a completely covers the component 3. After bluing of the component 3 in the first reactor 2, the component 3 is transported by means of the transport device 22, merely indicated diagrammatically, out of the first reactor 2 and into the heated further first reactor 2′.

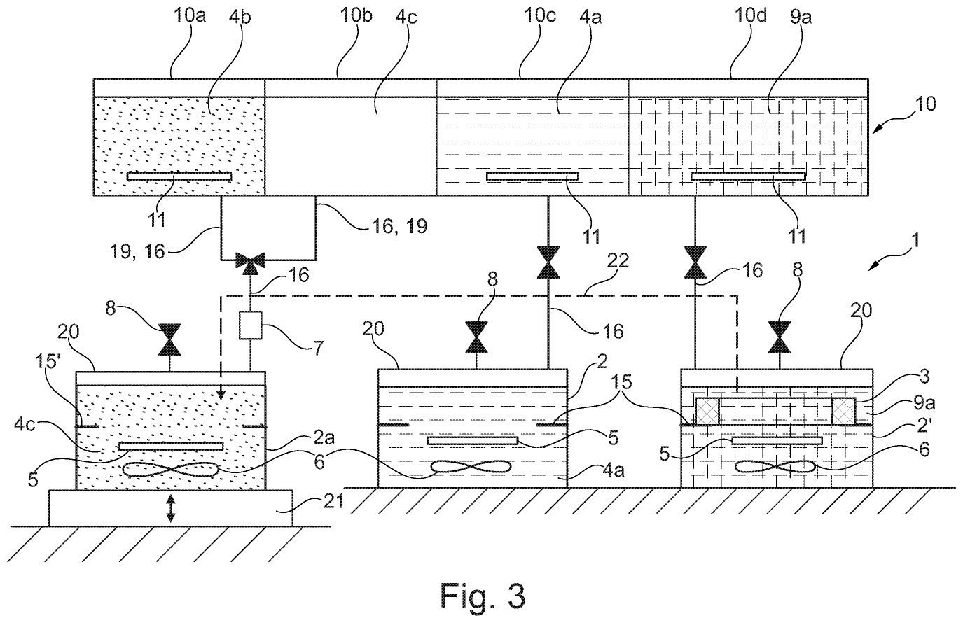

In FIG. 3, further bluing of the component 3 then takes place in the further first reactor 2′, which here corresponds to a second bluing reactor. The second bluing reactor uses, as a second main medium 9a, a further aqueous solution which has a higher nitrite concentration than the first main medium 4a. The nitrite concentration here in the second main medium 9a is preferably in the range from 140 g/l to 170 g/l. In an example embodiment, the component 3 remains for at least 12 minutes immersed into the second main medium 9a, the temperature of which is higher by from 3 Kelvin to 5 Kelvin than that of the first ancillary medium 4a. The nitrite in the second main medium 9a may likewise takes the form of sodium nitrite.

The second main medium 9a has been charged to the further first reactor 2′ in a manner such that the second main medium 9a completely covers the component 3. After completion of bluing of the component 3 in the further first reactor 2′, the component 3 is transported by means of the transport device 22, merely indicated diagrammatically, out of the further first reactor 2′ back into the heated second reactor 2a.

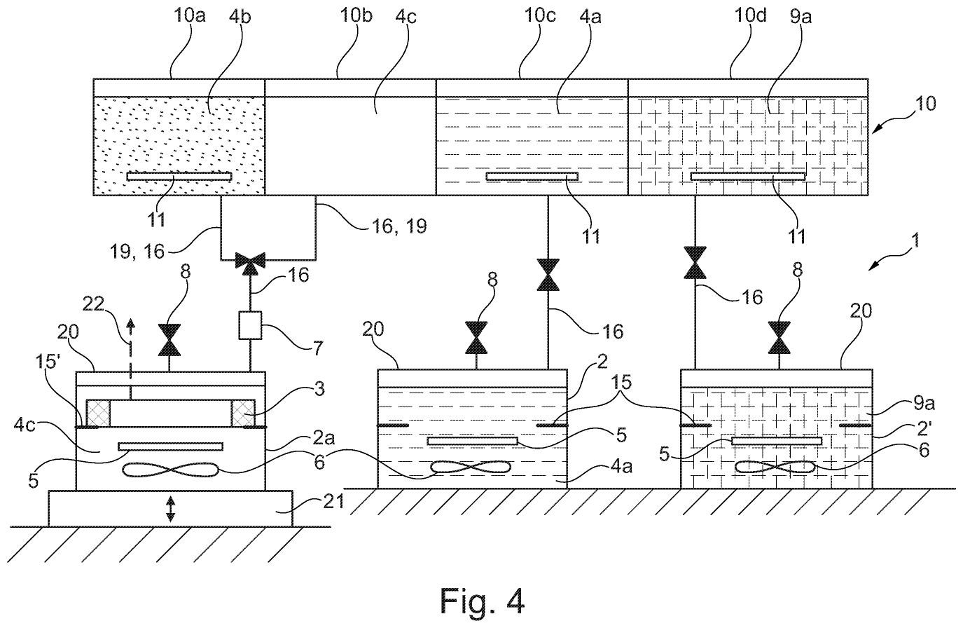

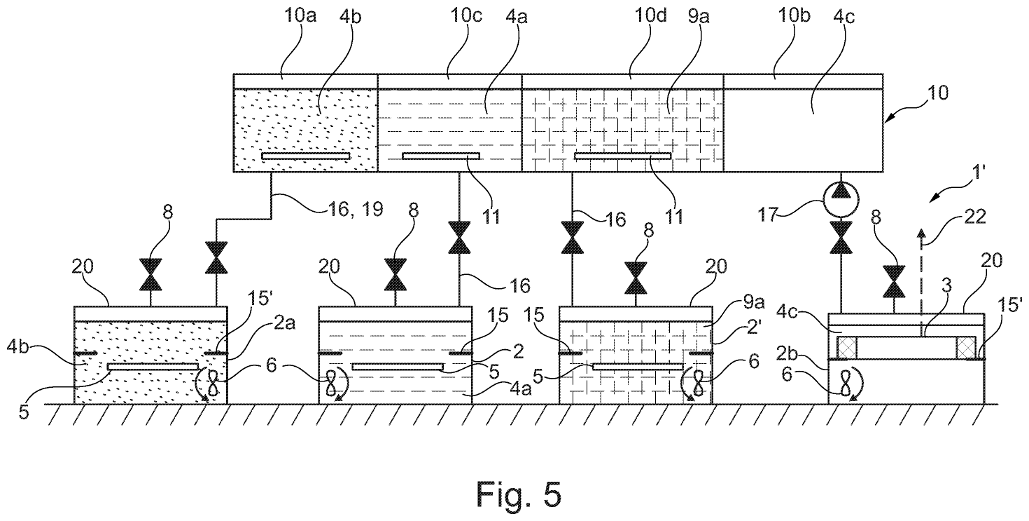

In FIG. 4, the blued component 3 is then rinsed in the second reactor 2a. During the conduct of the main procedure, the second reactor 2a has been lifted by means of the lifting platform 21 to a level above the external container 10a. By way of the discharge line 19, the filter 17 and the valve, the first ancillary medium 4b has been passed back, with the assistance of gravity, into the external container 10a. During this procedure, the second reactor 2a has been completely emptied. The valve has then been closed, and, by means of the lifting platform 21, the second reactor 2a has been lowered back to the level depicted in FIG. 1. There can also be a conveying device 17 provided (cf. FIG. 5), as an alternative to a lifting platform 21, an example being a pump, for pumping the first ancillary medium 4b back into the external container 10a.

The second ancillary medium 4c has then been charged, with the assistance of gravity, from the external container 10b to the second reactor 2a; the second ancillary medium 4c here takes the form of a rinsing solution.

The blued component 3 is introduced into the second ancillary medium 4c by means of the transport device 22, and rinsed. After rinsing, the component 3 is removed in finished form from the second reactor 2a by means of the transport device 22.

In order to recommence the process for a further component, the second ancillary medium 4c is transferred back into the external container 10b. This can take place in the manner already described above for the first ancillary medium 4b. The first ancillary medium 4b is again charged to the second reactor 2a, and the process is repeated as described for the further component.

Alternatively, it is possible to carry out the process simultaneously on three components in the following manner: after transfer of a first component from the second reactor 2a into the first reactor 2, a second component is in turn immediately charged to the second reactor 2a. After transfer of the first component from the first reactor 2 into the further first reactor 2′, the second component is then passed into the first reactor 2 and a third component is charged to the second reactor 2a. After removal of the first component from the further reactor 2′, it is followed by the second component. The third component then follows into the first reactor 2. The change of the ancillary medium in the second reactor 2a is delayed until this juncture, and all three components are rinsed in succession.

FIG. 5 is a diagrammatic sectional side view of a second reactor apparatus 1′. Reference signs which are the same as those in FIGS. 1 to 4 indicate the same elements. In a difference from the first reactor apparatus 1 in FIGS. 1 to 4, there is a further second reactor 2b provided here. This permits spatial separation between the ancillary procedure of rinsing and the ancillary procedure of degreasing. Conduct of the process here is analogous to that described above in relation to FIGS. 1 to 3. Process time is also reduced by virtue of the additional second reactor 2b. In a difference from the process described in FIG. 4, however, after the component 3 has been removed from the further first reactor 2′ it is introduced here into the further second reactor 2b and rinsed by means of a second ancillary medium 4c in the form of a rinsing solution.

After rinsing, the blued component 3 in finished form is removed by means of a transport device 22 from the further second reactor 2b. The rinsing solution here is water, which can be pumped into the external container 10b by way of a conveying device 17 and can be cleaned by way of a cleaning circuit not depicted, connected to the external container 10b. The stirrer apparatuses 8 have been provided here laterally on the respective reactor in order to achieve directional flow of the medium in the reactor. The resultant flow here, viewed from above a reactor, would be circular. Moreover, fluidization of sludge that settles at the bottom of the reactor can be prevented by arranging the stirrer apparatuses 8 in the upper region of the respective reactor.

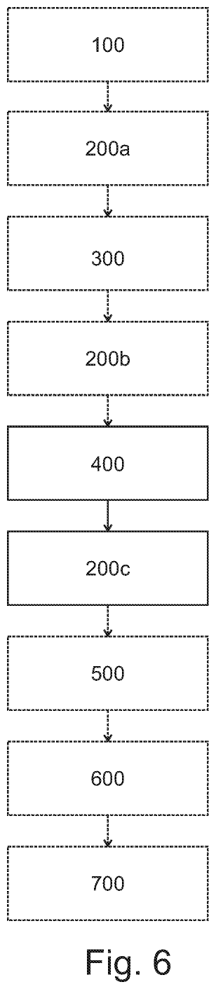

FIG. 6 depicts a possible bluing process sequence in a flow diagram. The individual steps of the process sequence are carried out in the sequence set out below:

The process sequence comprises an ancillary procedure 100. The ancillary procedure 100 is configured as a cleaning procedure. The ancillary medium of the ancillary procedure 100 is configured as a cleaning agent, and cleans the component 3 by removing contaminants. Alternatively and/or additionally, the ancillary medium of the ancillary procedure 100, for example a first ancillary medium 4b as in FIGS. 1 to 4, comprises a degreasing agent and cleans the component 3 by removing grease residues. Specifically, the ancillary medium is configured to remove unevenness and/or scratching on the surface of the component 3, for example by etching the surface of the component 3.

The process sequence in FIG. 6 comprises a further ancillary procedure 200a. The further ancillary procedure 200a is configured as a first rinsing procedure. The ancillary medium of the ancillary procedure 200a is configured as a first rinsing agent. The first rinsing agent of the ancillary procedure 200a rinses the component 3 and removes residues of the ancillary medium of the preceding ancillary procedure 100.

The process sequence in FIG. 6 also comprises a further ancillary procedure 300. The ancillary procedure 300 is configured as an activation procedure. The ancillary medium of the ancillary procedure 300 is configured as an activation medium. The activation medium of the ancillary procedure 300 activates the component 3. Specifically, the activation medium acts as a bluing catalyst. Alternatively and/or additionally, the ancillary medium of the ancillary procedure 300 can be configured as a conditioning medium; this assists the chemical reaction desired in the main procedure.

The process sequence in FIG. 6 comprises a further ancillary procedure 200b. The ancillary procedure 200b is configured as a second rinsing procedure. The ancillary medium of the ancillary procedure 200b is configured as a second rinsing agent. The second rinsing agent of the ancillary procedure 200b rinses the component 3 and removes residues of the ancillary medium of the preceding ancillary procedure 300.

The process sequence in FIG. 6 then comprises the main procedure 400. The main procedure 400 is configured as a bluing procedure. The main medium of the main procedure 400 comprises, as described above, the first main medium 4a and the second main medium 9a, which are configured as bluing agents.

The process sequence in FIG. 6 then comprises a further ancillary procedure 200c. The ancillary procedure 200c is configured as a third rinsing procedure. The ancillary medium of the ancillary procedure 200c is configured as a third rinsing agent. The third rinsing agent of the ancillary procedure 200c rinses the component 3 and removes residues of the first main medium 4a and of the second main medium 9a of the preceding main procedure 400.

The process sequence in FIG. 6 comprises a further ancillary procedure 500. The ancillary procedure 500 is configured as a dewatering procedure. The ancillary medium of the ancillary procedure 500 is configured as a dewatering medium. The dewatering medium of the ancillary procedure 500 removes water residues from preceding procedures, in particular of the ancillary procedure 200c, the third rinsing procedure, from the surface of the component 3.

The process sequence in FIG. 6 comprises a further ancillary procedure 600. The ancillary procedure 600 is configured as an oiling procedure. The ancillary medium of the ancillary procedure 600 is an oil. The oil of the ancillary procedure 600 oils the surface of the component 3 and thus provides protection of the blued component 3 from corrosion.

Alternatively, the ancillary procedure 500 and the ancillary procedure 600 can be combined in a single ancillary procedure. The configuration of the oil here is such that it has a dewatering effect and thus removes water residues from the surface of the component 3 and oils the surface of the component 3.

Finally, there is a drying procedure 700 provided for the component 3.

However, other process sequences are also possible here, where one or more of the ancillary procedures can be omitted. It is moreover possible to treat a plurality of components simultaneously in a single reactor.

### REFERENCE NUMERALS

1 Reactor apparatus
1′ Reactor apparatus
2 First reactor
2′ First reactor
2a Second reactor
2b Second reactor
3 Component
4a Main medium
9a Main medium
4b First ancillary medium
4c Second ancillary medium
5 Heating element
6 Stirrer apparatus
7 Filter
8 Pressure-relief valve
10 Container arrangement
10a External container
10b External container
10c External container
10d External container
11 Preheating element
15 Holder device
15′ Holder device
16 Supply line
17 Conveying device
19 Discharge line
20 Cover
21 Lifting platform
22 Transport device
100 Ancillary procedure
200a Ancillary procedure
200b Ancillary procedure
300 Ancillary procedure
400 Main procedure
500 Ancillary procedure
600 Ancillary procedure
700 Drying procedure

1.-11. (canceled)

12. A process for surface modification of a component comprising:
providing a first reactor for a main procedure and a second reactor for an ancillary procedure;
charging the first reactor with a main medium;
providing a component to the first reactor;
performing the main procedure by bathing the component in the main medium to bring about a chemical change onto a surface of the component;
charging the second reactor with an ancillary medium;
providing the component to the second reactor;
performing the ancillary procedure by bathing the component in the ancillary medium to treat the surface of the component, wherein:
the chemical change is a surface modification that takes the form of bluing or phosphatizing;
the surface modification forms a conversion coating; and
the component comprises a diameter or dimensions in the range from 0.5 m to 12 m.

13. The process of claim 12, wherein:
the first reactor is closed after the step of providing a component to the first reactor; or
the second reactor is closed after the step of providing the component to the second reactor.

14. The process of claim 12 wherein:
charging the second reactor with an ancillary medium includes charging the ancillary medium from an external container to the second reactor; and
the process comprises the step of returning the ancillary medium to the external container after performing the ancillary procedure.

15. The process of claim 12 wherein the main medium is heated during the main procedure or the ancillary medium is heated during the ancillary procedure.

16. The process of claim 12 wherein the component is a bearing ring.

17. The process of claim 12 further comprising:
providing a first holding device in the first reactor for holding the component;
providing a second holding device in the second reactor for holding the component; and
providing a transport device for:
providing the component to the first reactor or the second reactor; and
removing the component from the first reactor or the second reactor.

18. The process of claim 12 wherein:
the first reactor comprises a plurality of first reactors;
the second reactor comprises a plurality of second reactors;
m represents a total number of first reactors and second reactors;
the process comprises the step of providing n external containers for charging the plurality of first reactors and the plurality of second reactors; and
n≥m.

19. A process for surface modification of a component comprising:
providing a first ancillary reactor, a second ancillary reactor, and a first main reactor;
charging the first ancillary reactor with a first ancillary agent;
providing a component to the first ancillary reactor;
performing a first ancillary procedure by degreasing the component with the first ancillary agent;
charging the second ancillary reactor with a second ancillary agent;
providing the component to the second ancillary reactor;
performing a second ancillary procedure by rinsing the component or nucleating the component with the second ancillary agent;
charging the first main reactor with a first main medium;
providing the component to the first main reactor;
performing a first main procedure by bathing the component in the first main medium to bring about a chemical change onto a surface of the component;
the chemical change is a surface modification that takes the form of bluing or phosphatizing;
the surface modification forms a conversion coating; and
the component comprises a diameter or dimensions in the range from 0.5 m to 12 m.

20. The process of claim 19 further comprising:
providing a second main reactor;
charging the second main reactor with a second main medium;
providing the component to the second main reactor; and
performing a second main procedure by bathing the component in the second main medium to bring about a further chemical change onto the surface of the component.

21. The process of claim 19, wherein:
the first ancillary reactor is closed after the step of providing a component to the first ancillary reactor;
the second ancillary reactor is closed after the step of providing the component to the second ancillary reactor; and
the first main reactor is closed after the step of providing the component to the first main reactor.

22. The process of claim 19 wherein:
the first main medium is heated during the first main procedure;
the first ancillary agent is heated during the first ancillary procedure; or
the second ancillary agent is heated during the second ancillary procedure.

23. The process of claim 19 wherein the component is a bearing ring.

24. The process of claim 19 further comprising:
providing a first holding device in the first ancillary reactor for holding the component;
providing a second holding device in the second ancillary reactor for holding the component;
providing a third holding device in the first main reactor for holding the component; and
providing a transport device for:
providing the component to the first ancillary reactor or the second ancillary reactor or the first main reactor; and
removing the component from the first ancillary reactor or the second ancillary reactor or the first main reactor.
